(19) United States
(12) Patent Application Publication
(10) Pub. No.: US 2026/0213621 A1
(43) Pub. Date: Jul. 23, 2026

(54) DRIVE DEVICE

(71) Applicant: DENSO CORPORATION, Kariya-city (JP)

(72) Inventors: Tomohiro AOYAMA, Kariya-city (JP); Atsushi KATO, Kariya-city (JP); Nobuhiko URYU, Kariya-city (JP)

(21) Appl. No.: 19/572,044

(22) Filed: Mar. 19, 2026

Related U.S. Application Data
(63) Continuation of application No. PCT/JP2024/035725, filed on Oct. 7, 2024.

(30) Foreign Application Priority Data
Oct. 18, 2023 (JP) 2023-179371

(51) Int. Cl. H02K 9/22; H02K 1/12; H02K 3/04; H02K 5/04; H02K 7/00

(52) U.S. Cl. CPC H02K 9/22; H02K 1/12; H02K 3/04; H02K 5/04; H02K 7/003

(57) ABSTRACT

A circuit unit of a drive device includes a circuit board on which electronic components are mounted. The circuit board extends outward beyond a motor region that overlaps with a motor unit. A housing includes a housing main body and a cover. The housing main body has a motor housing portion, which receives the motor unit, and a circuit housing portion, which receives the circuit unit and is formed integrally in one-piece with the motor housing portion. The cover covers an opening of the housing main body. At least one of the housing main body and the cover is configured to receive heat generated from the circuit unit. The housing has heat dissipation portions. The heat dissipation portions include peripheral-wall heat dissipation portions, each of which projects from a peripheral wall portion of the housing that surrounds an outer periphery of the circuit board.

### CROSS REFERENCE TO RELATED APPLICATIONS

This application is a continuation application of International Patent Application No. PCT/JP2024/035725 filed on October 7, 2024, which designated the U.S. and claims the benefit of priority from Japanese Patent Application No. 2023-179371 filed on October 18, 2023. The entire disclosures of all of the above applications are incorporated herein by reference.

### TECHNICAL FIELD

The present disclosure relates to a drive device.

### BACKGROUND

Previously, a motor of integrated electromechanical type, which includes a control circuit board for controlling a motor main body, has been known. In one such motor, a heat sink is formed by: a bearing holder, which has a holder main body and a projection; and a heat transfer member.

### SUMMARY

According to the present disclosure, there is provided a drive device that may include a motor unit, a circuit unit and a housing. The motor unit may include: a stator around which a plurality of motor windings are wound; a rotor that is configured to be rotated in response to energization of the plurality of motor windings; and a shaft that is configured to be rotated integrally with the rotor. The circuit unit may include a circuit board on which a plurality of electronic components configured to control the energization of the plurality of motor windings are mounted. The circuit board extends outward beyond a motor region that overlaps with the motor unit when the motor unit is projected onto the circuit board in an axial direction of the motor unit. The housing may include: a housing main body that has a motor housing portion, which receives the motor unit, and a circuit housing portion, which receives the circuit unit and is formed integrally in one-piece with the motor housing portion; and a cover that covers an opening of the housing main body which opens at the circuit housing portion, wherein at least one of the housing main body and the cover is configured to receive heat generated from the circuit unit. The housing may have a plurality of heat dissipation portions. The plurality of heat dissipation portions may include a plurality of peripheral-wall heat dissipation portions, each of which may project from a peripheral wall portion of the housing that surrounds an outer periphery of the circuit board.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic view showing an electric motorcycle to which a drive device according to a first embodiment is applied.

FIG. 2 is a cross-sectional view of the drive device according to the first embodiment.

FIG. 3 is a side view of the drive device according to the first embodiment.

FIG. 4 is a view in a direction of arrow IV in FIG. 3.

FIG. 5 is a view in a direction of arrow V in FIG. 3.

FIG. 6 is a side view of a drive device according to a second embodiment.

FIG. 7 is a view in a direction of arrow VII in FIG. 6.

FIG. 8 is a view in a direction of arrow VIII in FIG. 6.

FIG. 9 is a cross-sectional view taken along line IX-IX in FIG. 8.

FIG. 10 is a schematic view showing an electric motorcycle to which a drive device according to a third embodiment is applied.

FIG. 11 is a side view of the drive device according to the third embodiment.

FIG. 12 is a view in a direction of arrow XII in FIG. 11.

FIG. 13 is a view in a direction of arrow XIII in FIG. 11.

FIG. 14 is a view in a direction of arrow XIV in FIG. 11.

FIG. 15 is a cross-sectional view taken along line XV-XV in FIG. 14.

FIG. 16 is a side view of a drive device according to a fourth embodiment.

FIG. 17 is a view in a direction of arrow XVII in FIG. 16.

FIG. 18 is a view in a direction of arrow XVIII in FIG. 16.

FIG. 19 is a view in a direction of arrow XIX in FIG. 16.

FIG. 20 is a cross-sectional view taken along line XX-XX in FIG. 19.

FIG. 21 is a cross-sectional view of a drive device according to a fifth embodiment.

### DETAILED DESCRIPTION

Previously, a motor of integrated electromechanical type, which includes a control circuit board for controlling a motor main body, has been known. In one such motor, a heat sink is formed by: a bearing holder, which has a holder main body and a projection; and a heat transfer member.

In this motor, a surface area of a heat dissipating surface is relatively small, and heat dissipation into the air is limited.

A drive device of the present disclosure includes a motor unit, a circuit unit and a housing. The motor unit includes: a stator around which a plurality of motor windings are wound; a rotor that is configured to be rotated in response to energization of the plurality of motor windings; and a shaft that is configured to be rotated integrally with the rotor. The circuit unit includes a circuit board on which a plurality of electronic components configured to control the energization of the plurality of motor windings are mounted. The circuit board extends outward beyond a motor region that overlaps with the motor unit when the motor unit is projected onto the circuit board in an axial direction of the motor unit.

The housing includes: a housing main body that has a motor housing portion, which receives the motor unit, and a circuit housing portion, which receives the circuit unit and is formed integrally in one-piece with the motor housing portion; and a cover that covers an opening of the housing main body which opens at the circuit housing portion. At least one of the housing main body and the cover is configured to receive heat generated from the circuit unit. The housing has a plurality of heat dissipation portions. The plurality of heat dissipation portions include a plurality of peripheral-wall heat dissipation portions, each of which projects from a peripheral wall portion of the housing that surrounds an outer periphery of the circuit board. With the above configuration, heat dissipation efficiency for dissipating the heat can be increased.

Hereinafter, a drive device of the present disclosure will be described with reference to the drawings. In the following description, the same reference signs are given to substantially the same portions among the embodiments, and the redundant description thereof will be omitted for the sake of simplicity.

### First Embodiment

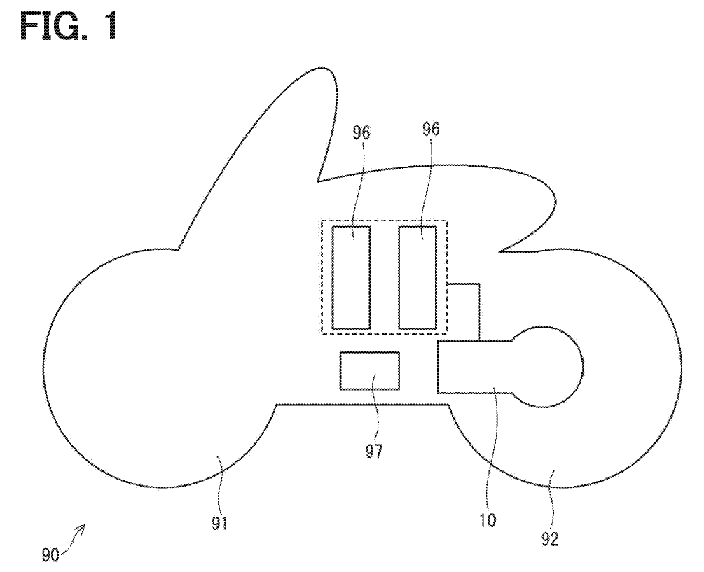

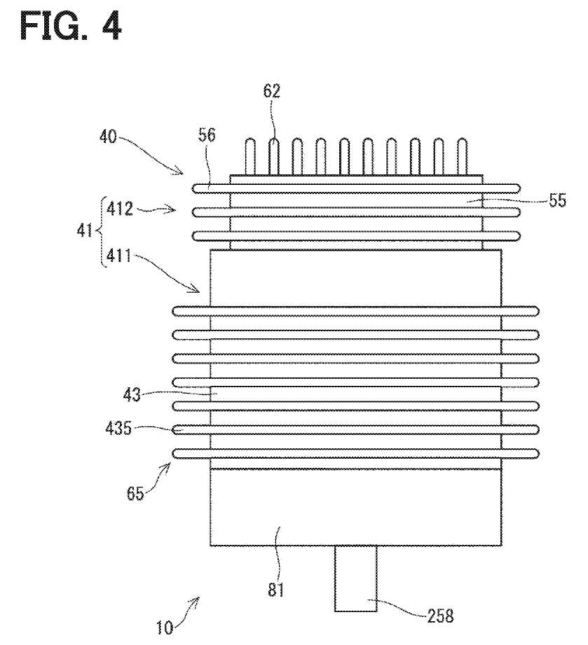

FIGS. 1 to 5 show the first embodiment. As shown in FIG. 1, a drive device 10 is applied, for example, to an electric motorcycle 90. The electric motorcycle 90 is provided with, for example, a plurality of main batteries 96 of 48 V, an auxiliary battery 97 of 12 V and the drive device 10. The drive device 10 is connected to the main batteries 96 and is driven by electric power supplied from the main batteries 96. In FIG. 1, the drive device 10 is provided on a rear wheel 92 of the electric motorcycle 90. However, the drive device 10 may be provided on a front wheel 91 or on each of the front and rear wheels 91, 92.

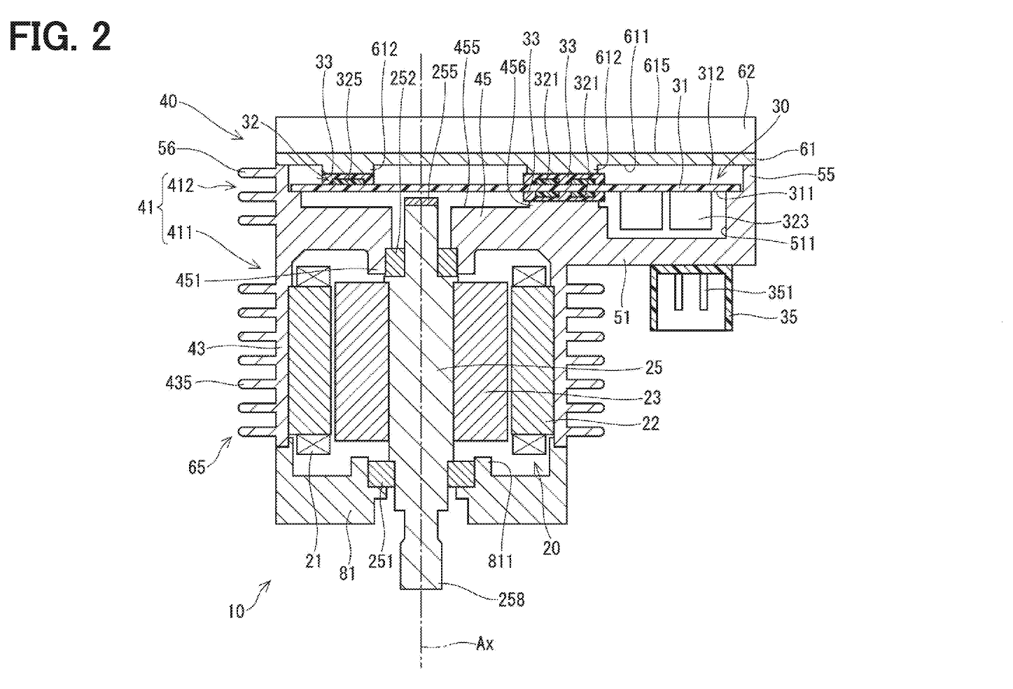

As shown in FIGS. 2 to 5, the drive device 10 includes a motor unit 20, a circuit unit 30 and a housing 40. The drive device 10 is a so-called "integrated electromechanical type" in which the circuit unit 30 is provided on one axial side of the motor unit 20.

The motor unit 20 is, for example, a three-phase brushless motor, and a drive force of the motor unit 20 is transmitted to the rear wheel 92 via gears (not shown). The electric motorcycle 90 travels by the drive force of the motor unit 20, and the motor unit 20 is a traction motor (so-called main motor).

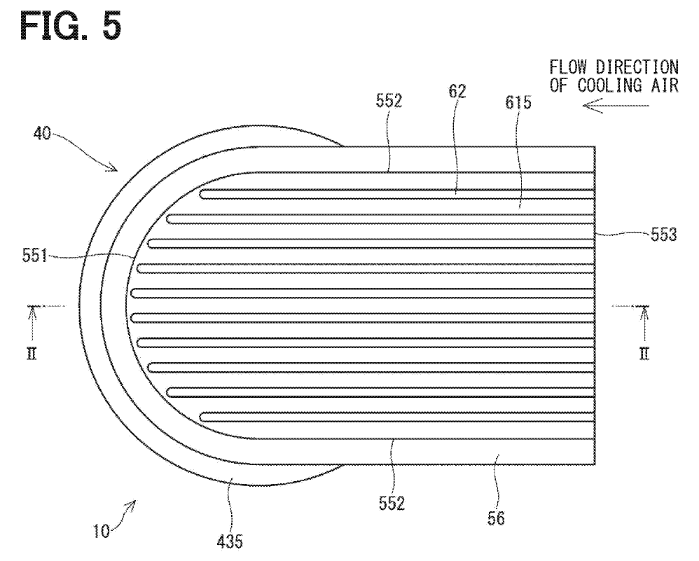

FIG. 2 is a cross-sectional view taken along line II-II in FIG. 5. As shown in FIG. 2, the motor unit 20 includes: a stator 22 around which the motor windings 21 are wound; a rotor 23; and a shaft 25. The stator 22 is fixed to the housing 40. The rotor 23 is disposed on the radially inner side of the stator 22 and is configured to be rotated relative to the stator 22.

The shaft 25 is fitted into the rotor 23 to rotate integrally with the rotor 23. The shaft 25 is rotatably supported by bearings 251, 252. One end portion of the shaft 25 is exposed from the housing 40 toward the circuit unit 30, and a magnet 255 is installed to the one end portion of the shaft 25. The other end portion of the shaft 25 is an output end 258 and is exposed from the housing 40 on the side opposite to the circuit unit 30. The output end 258 is connected to the rear wheel 92 via a speed reducer (not shown). Accordingly, the rear wheel 92 is driven by the drive force of the motor unit 20.

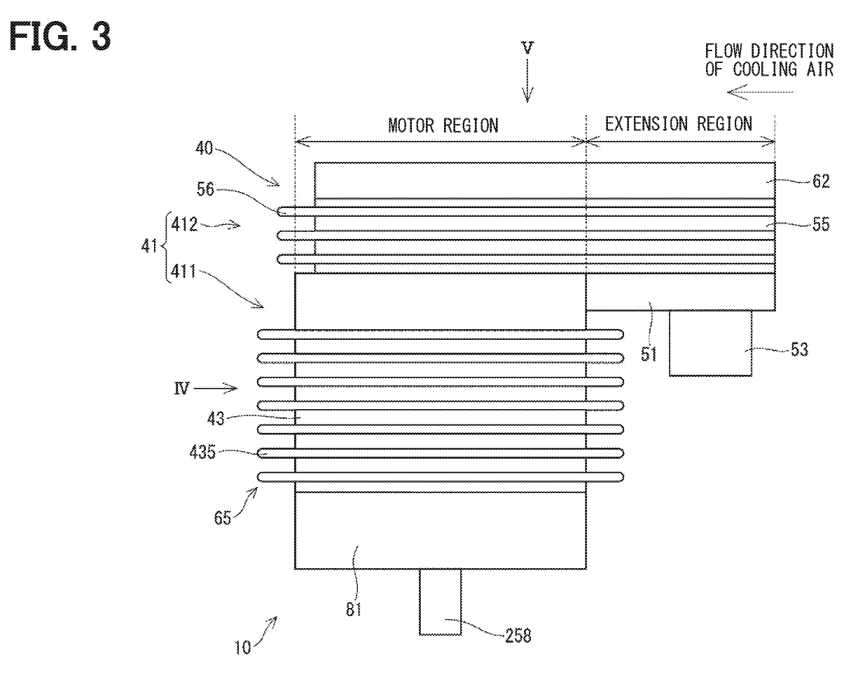

A virtual line, which is formed by extending a central axis of the shaft 25, is defined as a rotational axis Ax. Further, an axial direction of the motor unit 20 is hereinafter referred to as a motor axial direction or simply an axial direction. In the axial direction, a lower side in a sheet of FIG. 2 is defined as an output end side, and an upper side in the sheet of FIG. 2 is defined as a cover side. Furthermore, a region, which is obtained by axially projecting a tubular portion 43 of a housing main body 41 described later, is defined as a motor region, and a region extending outside the motor region is defined as an extension region (see FIG. 3). Hereinafter, descriptions of the motor region and the extension region are omitted to avoid undue complexity, except in FIG. 3.

The circuit unit 30 includes a circuit board 31. The circuit board 31 is fixed to the housing 40 by fixing members such as screws (not shown) and extends to the outside of the motor region on one side in the radial direction. Various electronic components 32 associated with motor control are mounted on the circuit board 31. Hereinafter, a surface of the circuit board 31, which faces the motor unit 20, will be referred to as a motor-side surface 311, and another surface of the circuit board 31, which is opposite to the motor unit 20, will be referred to as a cover-side surface 312.

The electronic components 32 include a plurality of switching devices 321, a plurality of tall components (e.g., capacitors) 323, and a control component 325 such as a microcomputer. The switching devices 321 constitute an inverter for switching energization of the motor windings 21 and are mounted on the motor-side surface 311 and the cover-side surface 312 of the circuit board 31. In the present embodiment, some of the switching devices 321 are mounted outside the motor region. The tall components 323 are mounted on the motor-side surface 311 of the circuit board 31 at a location outside the motor region. The control component 325 is mounted on the cover-side surface 312 of the circuit board 31 in the motor region.

The connector 35 is provided in the extension region, and connector terminals 351 of the connector 35 are connected to the circuit board 31. In the present embodiment, an opening of the connector 35 faces the output end side, and an insertion/removal direction of a harness (not shown) is a direction parallel to the rotational axis Ax. The orientation of the opening and the insertion/removal direction may be different. By providing the connector 35 in the extension region, dead space resulting from extending the circuit unit 30 radially outward from the motor region can be effectively utilized.

As shown in FIGS. 2 to 5, the housing 40 includes the housing main body 41, a cover 61 and a frame member 81. The housing main body 41 is integrally made of a metal material such as aluminum and has a motor housing portion 411, which receives the motor unit 20, and a circuit housing portion 412, which receives the circuit unit 30. The housing main body 41 includes the tubular portion 43, a heat sink 45, an extension 51 and a peripheral wall portion 55 and is integrally made of the metal material such as aluminum. When the housing 40 is viewed from the cover side, the housing 40 is formed, as a whole, into a shape that combines a semicircle and a rectangle. The semicircular portion of the housing 40 has a diameter smaller than that of the tubular portion 43 and is provided within the motor region. The rectangular portion of the housing 40 is formed so as to extend from the semicircular portion to outside the motor region.

In the present embodiment, the tubular portion 43 and a portion of the heat sink 45, which faces the output end side, form the motor housing portion 411. Furthermore, another portion of the heat sink 45, which faces the cover side, the extension 51 and the peripheral wall portion 55 form the circuit housing portion 412. In other words, the heat sink 45 can be regarded as a partition wall that partitions between the motor unit 20 side and the circuit unit 30 side, and the heat sink 45 is shared by both the motor housing portion 411 and the circuit housing portion 412.

The stator 22 is fixed to a radially inner side of the tubular portion 43. A plurality of heat dissipation fins 435, each of which is shaped in a circular ring form, are integrally formed at a radially outer side of the tubular portion 43. The heat dissipation fins 435 project radially outward from the tubular portion 43 such that the heat dissipation fins 435 are provided in a plurality of tiers and are thereby arranged in the axial direction. The frame member 81 is provided at an end of the tubular portion 43 on the output end side.

The frame member 81 is made of, for example, metal and is formed generally in a circular plate shape. The frame member 81 is attached to the end of the tubular portion 43 on the output end side by a plurality of fixing members such as screws so as to close the opening of the tubular portion 43. A bearing holding portion 811 is formed in the frame member 81. A bearing 251 is installed in the bearing holding portion 811.

The heat sink 45 is provided on the cover side of the tubular portion 43, and a bearing holding portion 451 is formed in the heat sink 45. A bearing 252 is installed in the bearing holding portion 451. Therefore, the shaft 25 is rotatably supported by the housing 40.

The extension 51 is formed continuously with the heat sink 45 and extends to a radially outer side of the tubular portion 43. Hereinafter, a direction, in which the extension 51 extends radially outward from the tubular portion 43, is referred to as an extension direction. A receiving recess 511 is formed on a surface of the extension 51 which faces cover side. The tall components 323 are received in the receiving recess 511.

The peripheral wall portion 55 is raised along an outer periphery of the heat sink 45 and the extension 51 such that the peripheral wall portion 55 is substantially perpendicular to the circuit board 31. The peripheral wall portion 55 includes a curved surface portion 551, which is raised in the semicircular portion, two side wall portions 552, which extend from the curved surface portion 551 to outside the motor region, and a distal end surface 553, which is an end surface of the peripheral wall portion 55 on the extension region side. A receiving space, which is surrounded by the surface of the heat sink 45 on the cover side, the extension 51 and the peripheral wall portion 55, receives the circuit board 31 and the electronic components 32 mounted on the circuit board 31.

The cover 61 is made of, for example, metal and is attached to the housing main body 41 by fixing members such as screws so as to close an opening of the housing main body 41 which faces the cover side. Accordingly, ingress of foreign matter such as water droplets and dust into the interior of the housing 40 can be limited.

In the present embodiment, the drive device 10 is connected to the main batteries 96. When a relatively high voltage (e.g.,96 V in the case where the two main batteries 96 of 48 V are connected in series), the drive device 10 becomes hot due to heat generation in the circuit unit 30 and the like, so thermal management is required. Accordingly, in the present embodiment, to promote heat dissipation from the circuit unit 30, a plurality of heat dissipation fins 56, 62 are provided on the circuit-housing side.

The heat dissipation fins 56 project outward from the peripheral wall portion 55. In the present embodiment, the heat dissipation fins 56 are formed continuously along one of the side wall portions 552, the curved surface portion 551 and the other one of the side wall portions 552 and project substantially perpendicular to the rotational axis Ax. In other words, the heat dissipation fins 56 are substantially parallel to the mounting surfaces of the circuit board 31. The heat dissipation fins 56 are provided in a plurality of tiers in the axial direction.

The heat dissipation fins 62 project substantially perpendicularly from an outer surface 615 of the cover 61, which is an end surface of the cover 61 opposite to the output end. In the present embodiment, the heat dissipation fins 62 are arranged in a plurality of rows such that each of the heat dissipation fins 62 is substantially parallel to the side wall portions 552 and extends from the motor region to the extension region. In the present embodiment, each of the heat dissipation fins 435, 56, 62 forms a heat dissipation portion 65.

As shown in FIG. 1, the drive device 10 is mounted on the electric motorcycle 90 such that the vehicle rear side corresponds to the motor region, and the vehicle front side corresponds to the extension region. Accordingly, the cooling air generated by running of the vehicle flows from the distal end side of the extension 51 toward the motor region (see FIGS. 3 and 5). Accordingly, in the present embodiment, the heat dissipation fins 56, 62 are formed along the extension direction so as to follow a flow of the cooling air. By forming the heat dissipation fins 56, 62 so as to follow the flow of the cooling air, the circuit unit 30 can be cooled with high efficiency by the cooling air.

As shown in FIG. 2, a heat receiving projection 456 is formed on a board facing surface 455 of the heat sink 45, which faces the circuit board 31. A plurality of heat receiving projections 612 are formed on an inner surface 611 of the cover 61. The heat receiving projections 456, 612 are formed in regions where the electronic components 32, which require heat dissipation, are mounted. In the present embodiment, the electronic components 32, which require the heat dissipation, are the switching devices 321 and the control component 325, and these are provided so as to be capable of dissipating heat to the heat receiving projections 456, 612 via a heat dissipation gel 33. In other words, in the present embodiment, the housing main body 41 and the cover 61 can be regarded as having, in addition to a function as an enclosure, a function as a heat sink involved in dissipating heat from the circuit unit 30. Accordingly, the heat, which is generated in the heat generating devices through the energization, can be dissipated with high efficiency.

In the present embodiment, the housing 40 has an unbalanced shape in which the circuit housing portion projects on one side in the radial direction beyond an outer diameter of the motor housing portion. By configuring the circuit unit 30 to project further than the motor unit 20, a required mounting area can be secured, and heat dissipation by the air cooling can be enhanced.

In addition, since the drive device 10 is applied to the electric motorcycle 90, there is a possibility that the drive device 10 will vibrate due to external forces such as wind pressure and vehicle vibrations. In the present embodiment, because the motor housing portion and the circuit housing portion are integrally molded to form the housing main body 41, loosening or damage at connections between the motor unit 20 and the circuit unit 30 caused by vibration can be prevented.

As described above, the drive device 10 includes the motor unit 20, the circuit unit 30 and the housing 40. The motor unit 20 includes: the stator 22 around which the plurality of motor windings 21 are wound; the rotor 23 that is configured to be rotated in response to energization of the plurality of motor windings 21; and the shaft 25 that is configured to be rotated integrally with the rotor 23. The circuit unit 30 includes the circuit board 31 on which the plurality of electronic components 32 configured to control the energization of the plurality of motor windings 21 are mounted. The circuit board 31 extends outward beyond the motor region that overlaps with the motor unit 20 when the motor unit 20 is projected onto the circuit board 31 in the axial direction of the motor unit 20.

The housing 40 includes the housing main body 41 and the cover 61. The housing main body 41 has the motor housing portion 411, which receives the motor unit 20, and the circuit housing portion 412, which receives the circuit unit 30 and is formed integrally in one-piece with the motor housing portion 411. The cover 61 covers the opening of the housing main body 41 which opens at the circuit housing portion 412. At least one of the housing main body 41 and the cover 61 is configured to receive the heat generated from the circuit unit 30.

The housing 40 has the plurality of heat dissipation portions 65. The heat dissipation portions 65 include the heat dissipation fins 56, each of which is formed integrally in one-piece with and projects from the peripheral wall portion 55 of the housing 40 that surrounds the outer periphery of the circuit board 31. By providing the heat dissipation fins 56, the surface area contributing to the heat dissipation is increased, and the thermal resistance is reduced, thereby enhancing heat dissipation of the circuit unit 30. Accordingly, higher-output operation of the motor becomes possible. In addition, in the present embodiment, the heat dissipation fins 56 are formed on the peripheral wall portion 55 that constitutes the circuit housing portion 412 in the housing main body 41. Thus, the heat dissipation fins 56 form a rib structure and can improve the strength of the circuit housing portion 412, which projects from the motor region.

In the housing main body 41, the heat receiving projection 456, on which the electronic components 32 requiring the heat dissipation therefrom are mounted, is formed on the board facing surface 455 that faces the circuit board 31. Furthermore, in the cover 61, each of the heat receiving projections 612, on which the electronic components 32 requiring the heat dissipation therefrom are mounted, is formed on the inner surface 611 that faces the circuit board 31. In the present embodiment, the electronic components, which require the heat dissipation, are the switching devices 321 and the control component 325.

By forming the heat receiving projections 456, 612, the heat generating devices can be brought closer to the housing 40, thereby improving the heat dissipation efficiency. Additionally, in a region other than the region where the electronic components requiring the heat dissipation are mounted, a space is created between the circuit board 31 and the housing 40, thereby increasing the degree of freedom in arranging the devices other than the heat generating devices.

The heat dissipation portions 65 include the heat dissipation fins 62 that are integrally formed in one-piece with the outer surface 615 which is parallel to the cover-side surface 312 that is the mounting surface of the circuit board 31. As a result, since the surface area, which contributes to the heat dissipation, increases, the heat dissipation efficiency of the circuit unit 30 can be improved.

The housing main body 41 has the tubular portion 43 that receives the motor unit 20 on the radially inner side of the tubular portion 43. The heat dissipation portions 65 include the heat dissipation fins 435, each of which is formed integrally in one-piece with and projects radially outward from the tubular portion 43. As a result, the heat dissipation efficiency for dissipating the heat from the motor unit 20 can be increased.

The electronic components 32 include the plurality of switching devices 321 that are configured to switch the energization among the plurality of motor windings 21. At least one of the plurality of switching devices 321 is disposed in the extension region of the circuit board 31 that is located outside the motor region. As a result, the high heat efficiency of the switching devices 321 can be improved.

The drive device 10 is configured to be mounted on the electric motorcycle 90 in a state where the drive device 10 is exposed to the outside of the electric motorcycle 90. The heat dissipation fins 56, 62, which are the heat dissipation portions formed on the circuit housing portion 412, are formed as a plurality of linear heat dissipation fins that are formed linearly to extend in the flow direction of the cooling air, which is generated when the electric motorcycle 90 is running. In the present embodiment, in order to use the air, which flows in a front-rear direction of the vehicle in response to the running of the vehicle, as the cooling air, the heat dissipation fins 56, 62 extend in the front-rear direction of the vehicle. As a result, the heat from the circuit unit 30 can be efficiently dissipated by the cooling air.

### Second Embodiment

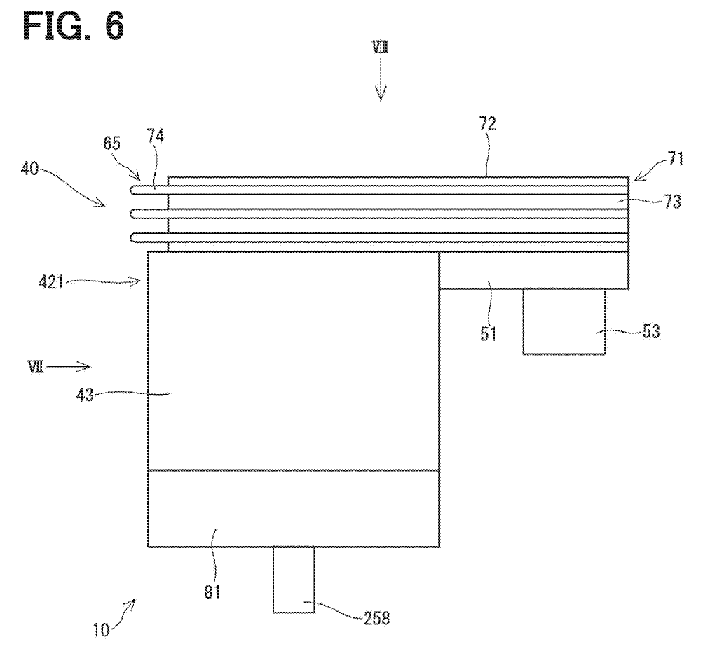

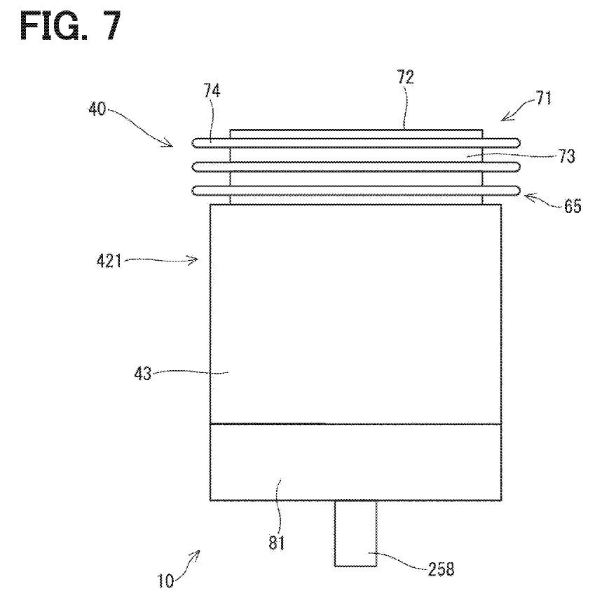

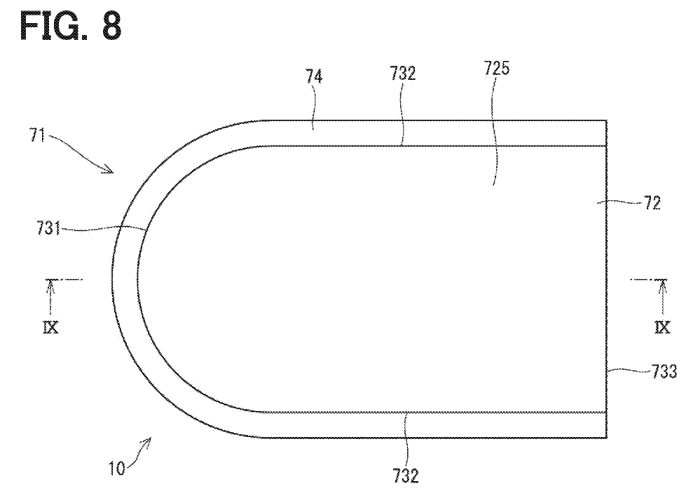

FIGS. 6 to 9 show the second embodiment. In the following embodiments, since the circuit housing portion and the cover differ from those in the above embodiment, the description will focus on these points. A housing main body 42 of the present embodiment includes the motor housing portion 421 and the circuit housing portion 422, which are made of a metal material and are formed integrally in one-piece, and the housing main body 42 includes the tubular portion 43, a heat sink 46 and an extension 52. In the present embodiment, for simplification, description of the heat dissipation fins 435 of the tubular portion 43 is omitted, but they may be formed in the same manner as in the first embodiment. The same applies to the fourth embodiment.

The heat sink 46 and the extension 52 have board fixing portions 461, 521 that project on the side opposite to the output end. The circuit board 31 is fixed to the board fixing portions 461, 521 by a plurality of fixing members such as screws (not shown). The board fixing portions 461, 521 are formed in a relatively outer region of the heat sink 46 and the extension 52 so as to be able to hold the outer periphery of the circuit board 31. In the present embodiment, none of the switching devices 321 is mounted on the motor-side surface 311 of the circuit board 31, and the heat receiving projection is not formed on a board facing surface 465 of the heat sink 46.

The cover 71 is formed in a substantially bottomed tubular shape to cover the circuit board 31 and has a cover portion 72 and a peripheral wall portion 73. The cover 71 is formed such that the cover portion 72 is located on the side opposite to the output end, and an opening of the peripheral wall portion 73 is located on the side where the output end is placed.

The cover portion 72 is formed generally similarly to the cover 61 of the first embodiment, and a plurality of heat receiving projections 722 are formed on an inner surface 721 of the cover portion 72. An outer surface 725 of the cover portion 72 of the present embodiment has no heat dissipation fins. However, the outer surface 725 may have the heat dissipation fins 62 similar to those of the first embodiment.

The peripheral wall portion 73 includes: a curved surface portion 731, which is formed in a semicircular portion of the peripheral wall portion 73; two side wall portions 732, which extend from the curved surface portion 731 to outside the motor region; and a distal end surface 733, which is an end surface of the peripheral wall portion 73 on the extension region side.

The heat dissipation fins 74 are formed integrally with the cover 71 such that the heat dissipation fins 74 project outward from the peripheral wall portion 73 and are provided in a plurality of tiers in the axial direction. In the present embodiment, the heat dissipation fins 74 are formed continuously along one of the side wall portions 732, the curved surface portion 731 and the other one of the side wall portions 732 and project substantially perpendicular to the rotational axis Ax. The heat dissipation fins 74 are included in the heat dissipation portions 65.

That is, in the first embodiment, the outer peripheral wall of the circuit housing portion 412 is formed by the peripheral wall portion 55 provided on the housing main body 41. In contrast, in the present embodiment, the outer peripheral wall of the circuit housing portion 422 is formed by the peripheral wall portion 73 provided on the cover 71.

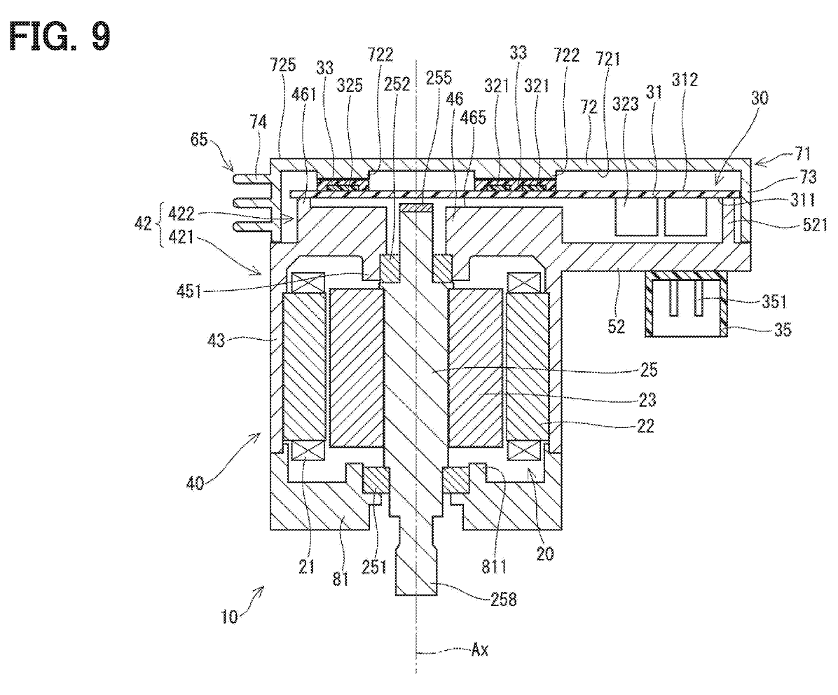

By providing the peripheral wall portion 73 on the cover 71 and forming the heat dissipation fins 74 on the peripheral wall portion 73, it is possible to improve the heat dissipation efficiency of the devices mounted on the cover-side surface 312 of the circuit board 31. FIG. 9 shows, as an example, a case in which none of the switching devices 321 is mounted on the motor-side surface 311 of the circuit board 31.

As in the example of FIG. 9, when it is desired to enhance the heat dissipation on the cover-side surface 312 rather than on the motor-side surface 311, it is preferable, in terms of heat dissipation, to provide the peripheral wall portion 73 on the cover 71. Further, when it is desired to enhance the heat dissipation on the motor-side surface 311 rather than on the cover-side surface 312, it is preferable to provide the peripheral wall portion 73 on the housing main body 41, as in the first embodiment.

In the present embodiment, the peripheral wall portion 73, which surrounds the outer periphery of the circuit board 31, is formed on the cover 71. The heat dissipation portions 65 include the heat dissipation fins 74, each of which is formed integrally in one-piece with and projects from the peripheral wall portion 73. As a result, the heat dissipation from the cover 71 can be increased. Furthermore, the advantages similar to those described in the above embodiment can be achieved.

### Third Embodiment

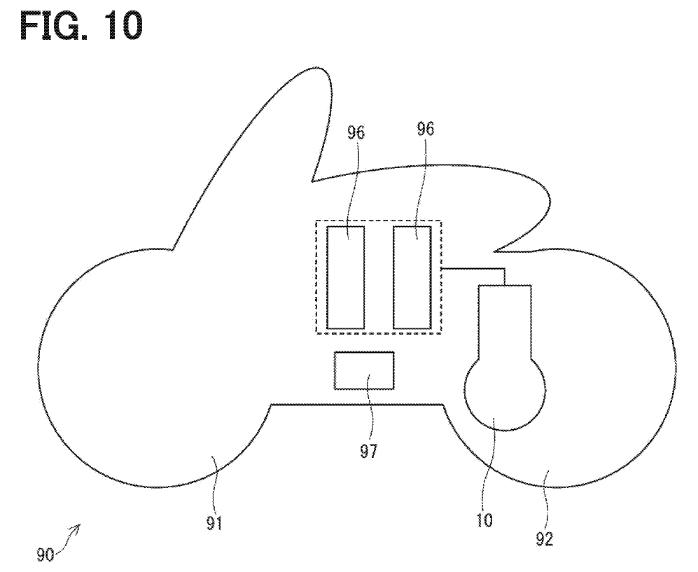

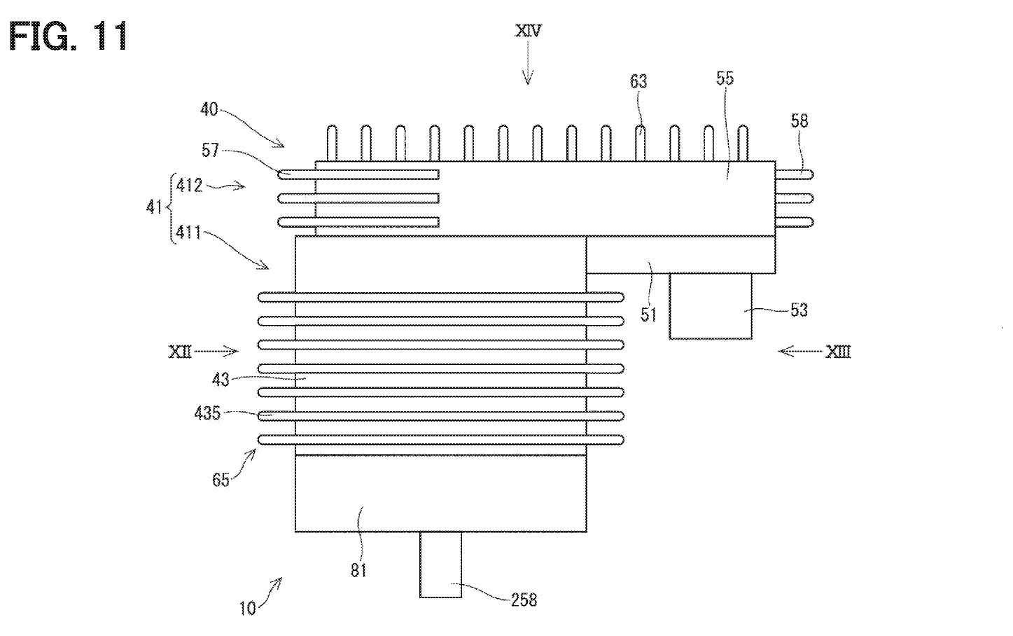

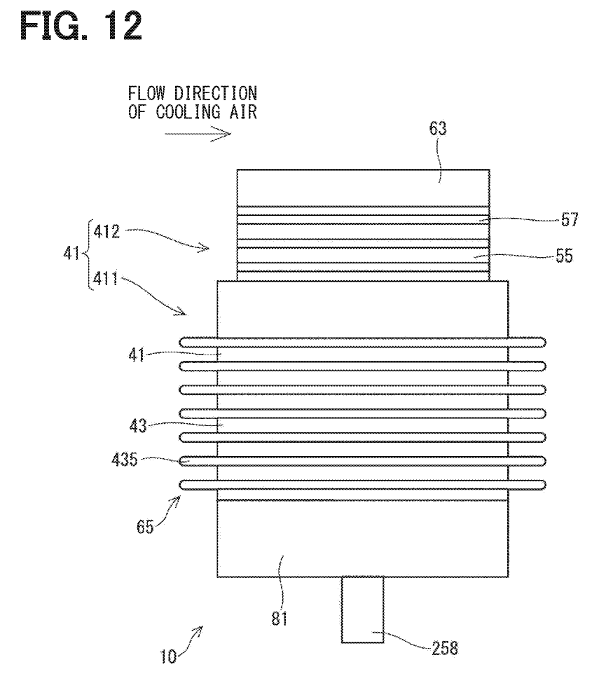

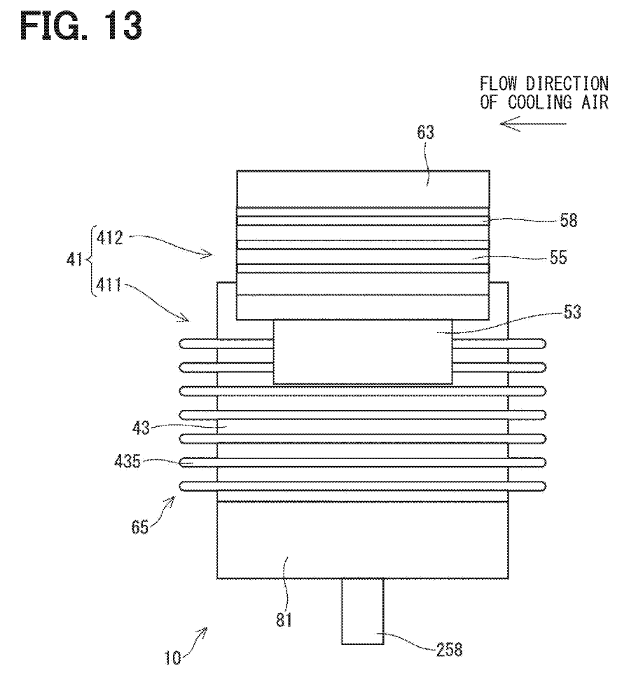

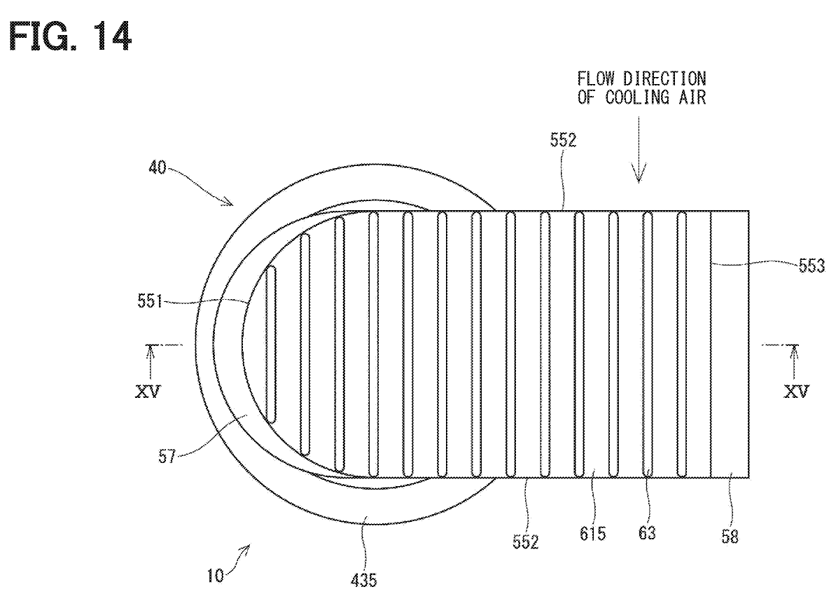

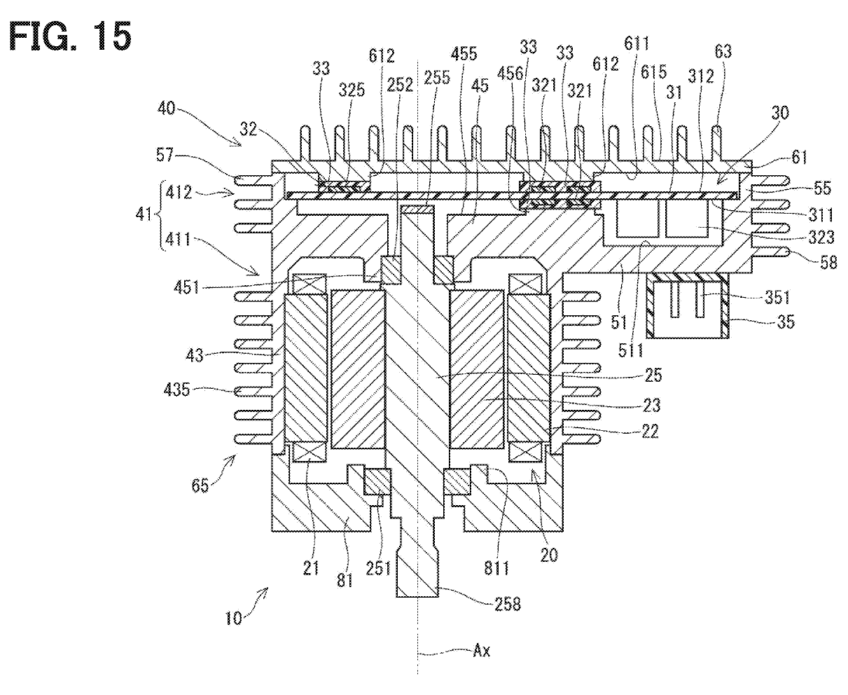

FIGS. 10 to 15 show the third embodiment. As shown in FIG. 10, in the present embodiment, the drive device 10 is mounted on the electric motorcycle 90 such that the lower side in the vertical direction serves as the motor region and the upper side serves as the extension region. Accordingly, the cooling air, which is generated by running of the vehicle, flows in a direction perpendicular to the extension direction (see, for example, FIG. 12). Therefore, in the present embodiment, as shown in FIGS. 11 to 15, the heat dissipation fins are formed along the direction perpendicular to the extension direction.

The heat dissipation fins 57, 58 project substantially perpendicular to the rotational axis Ax on the outer side of the peripheral wall portion 55 and are provided in a plurality of tiers in the axial direction. The heat dissipation fins 57 are formed on the curved surface portion 551, and the heat dissipation fins 58 are formed on the distal end surface 553.

The heat dissipation fins 63 project substantially perpendicular from the outer surface 615 of the cover 61. In the present embodiment, the heat dissipation fins 63 are arranged in a plurality of rows such that each of the heat dissipation fins 63 extends in a direction substantially parallel to the distal end surface 553 and perpendicular to the extension direction. In the present embodiment, the heat dissipation fins 57, 58, 63 are included in the heat dissipation portions 65.

### Fourth Embodiment

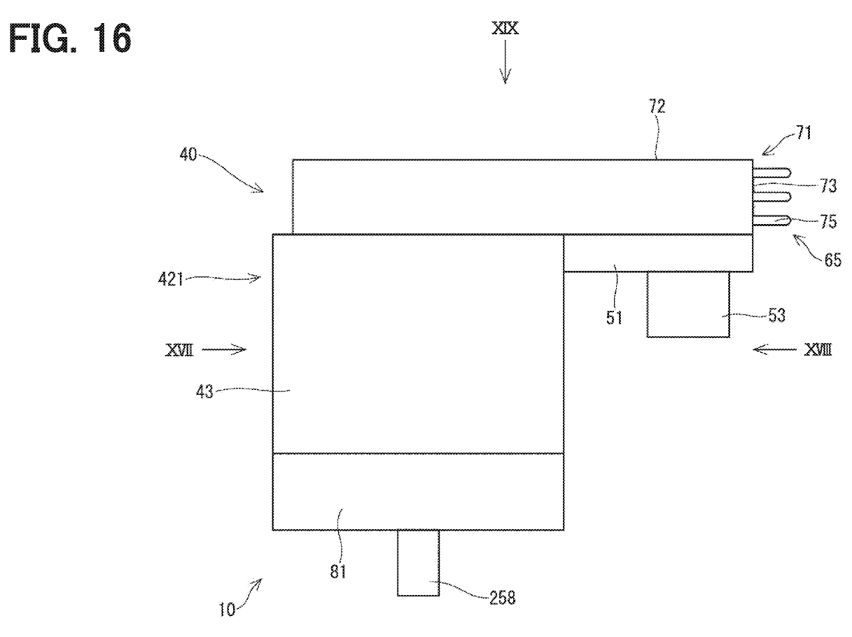

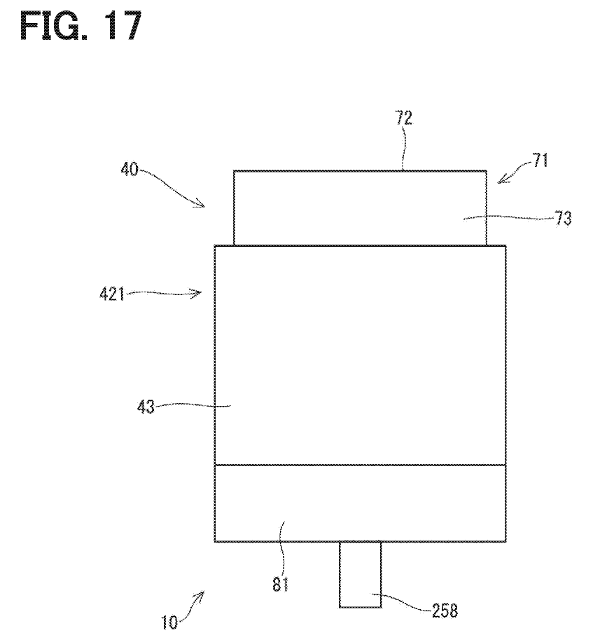

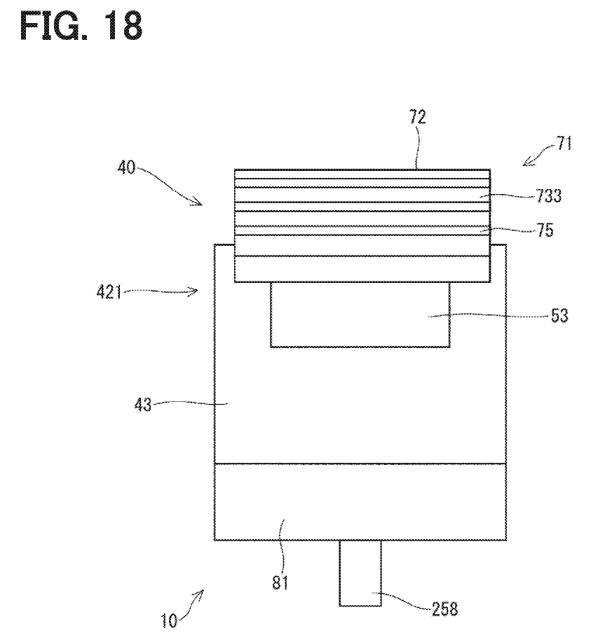

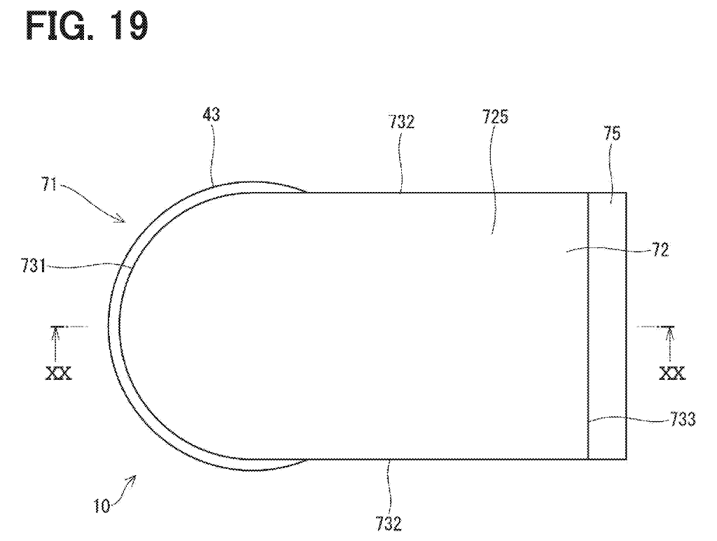

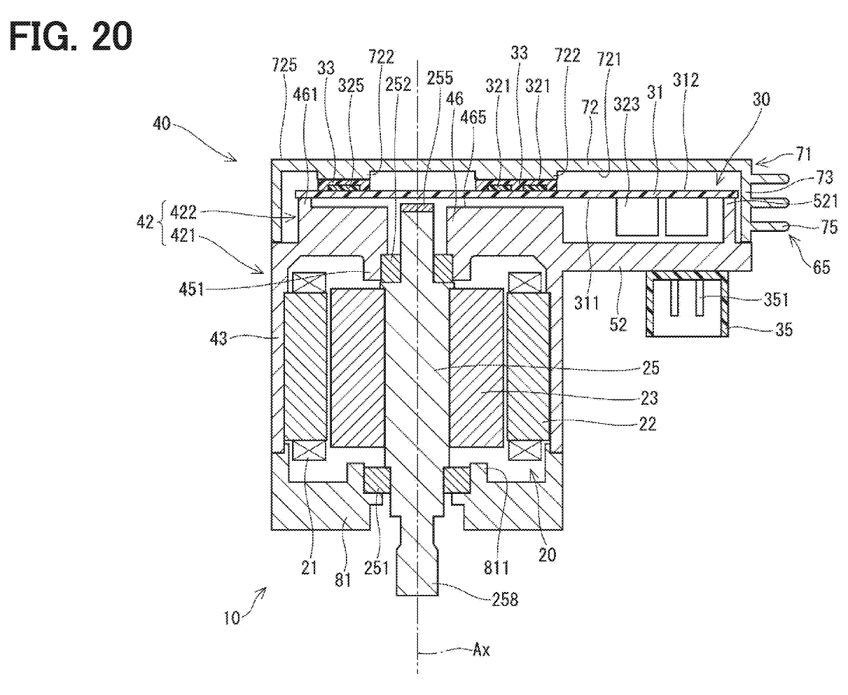

FIGS. 16 to 20 show the fourth embodiment. In the present embodiment, as in the second embodiment, the peripheral wall portion 73 is provided on the cover 71. The heat dissipation fins 75 project substantially perpendicular to the rotational axis Ax on the outer side of the peripheral wall portion 73 and are provided in a plurality of tiers in the axial direction. In the present embodiment, the heat dissipation fins 75 are included in the heat dissipation portions 65.

In the present embodiment, although the heat dissipation fins 75 are formed on the distal end surface 733, heat dissipation fins may also be provided on the curved surface portion 731, as in the third embodiment. The outer surface 725 of the present embodiment has no heat dissipation fins. However, the outer surface 725 may have the heat dissipation fins 63 similar to those of the third embodiment.

In the third and fourth embodiments, the heat dissipation fins 57, 58, 63, 75 project perpendicular to the extension direction. Accordingly, when the drive device 10 is mounted on the electric motorcycle 90 in the orientation shown in FIG. 10, the heat dissipation fins 57, 58, 63, 75 are arranged to extend along the flow of the cooling air. This makes it possible to dissipate the heat from the circuit unit 30 with high efficiency. Even with such a configuration, advantages similar to those of the above embodiment(s) can be achieved.

### Fifth Embodiment

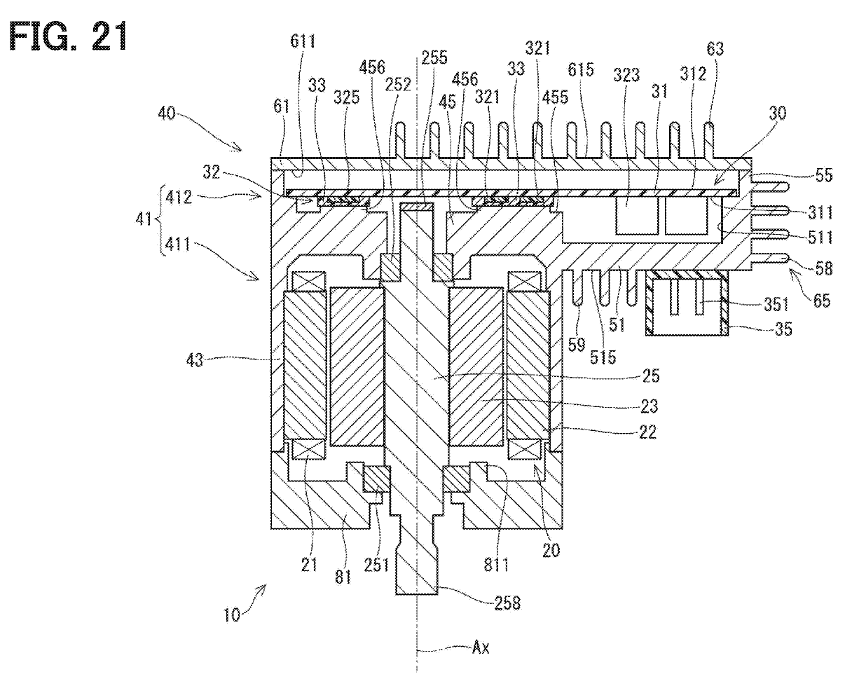

FIG. 21 shows the fifth embodiment. In the present embodiment, the switching devices 321 and the control component 325 are mounted on the motor-side surface 311. Further, all of the switching devices 321 are disposed within the motor region.

An outer surface 515 of the extension 51, which faces the output end side, is parallel to the motor-side surface 311, which is the mounting surface of the circuit board 31, and a plurality of heat dissipation fins 59 are integrally formed with and project from the outer surface 515. The heat dissipation fins 59 are formed on a side of the connector 35, which is adjacent to the tubular portion 43, such that the heat dissipation fins 59 are arranged in a plurality of rows and are substantially parallel to the distal end surface 553. This makes it possible to enhance the heat dissipation of the devices mounted in the extension region of the motor-side surface 311 of the circuit board 31. Even with such a configuration, advantages similar to those of the above embodiment(s) can be achieved. In the present embodiment, the heat dissipation fins 59 are included in the heat dissipation portions 65.

In the embodiments described above, the motor-side surface 311 and the cover-side surface 312 serve as the mounting surfaces, and the switching devices 321 and the control component 325 serve as the electronic components which require the heat dissipation. Furthermore, the heat dissipation fins 56, 57, 58, 74, 75 serve as a plurality of peripheral-wall heat dissipation portions, and each of the board facing surface 455 and the inner surfaces 611, 721 serve as a board facing surface. Additionally, the heat dissipation fins 59, 62, 63 serve as a plurality of parallel-surface heat dissipation portions, and the heat dissipation fins 435 serve as a plurality of motor heat dissipation portions. It should be noted that terms such as “parallel” and “perpendicular” allow for tolerances within a range that can be regarded as parallel or perpendicular. Further, the electric motorcycle 90 serves as a vehicle.

### Other Embodiments

In the above embodiments, the heat dissipation fins on the circuit housing portion are parallel or perpendicular to the extension direction in accordance with the mounting orientation of the drive device on the electric motorcycle. In another embodiment, the heat dissipation fins may be formed so as to be inclined with respect to the extension direction, i.e., inclined in a direction other than a direction parallel or perpendicular to the extending direction. Further, in the above embodiments, the plurality of heat dissipation fins are formed linearly and continuously from the one side to the other side and are arranged in parallel. In another embodiment, each of the heat dissipation fins may be formed intermittently, and may be arranged non-parallel, for example, radially. Further, the shape and arrangement of the heat dissipation portions may be different from those in the above embodiments.

In the above embodiments, the control component is located on the side of the circuit board relatively close to the curved surface portion of the peripheral wall, and the switching devices are mounted in a boundary region between the motor region and the extension region. Furthermore, the tall components are mounted in the extension region. Further, in the above embodiments, in the example of FIG. 2, the heat generating devices are mounted on the two surfaces of the circuit board, which are opposite to each other, and in the example of FIG. 9, the heat generating devices are mounted on the cover-side surface of the circuit board. Furthermore, in the example of FIG. 21, the heat generating devices are mounted on the motor-side surface of the circuit board. In another embodiment, the arrangement of the electronic components together with the mounting surface(s) may be different from that in the above embodiments. In the above embodiments, the electronic components, which require the heat dissipation, are the switching devices and the control component. In another embodiment, electronic components, which are other than the switching devices and the control component, may be regarded as electronic components, which require heat dissipation, and heat receiving projections may be formed at mounting locations of those electronic components. Further, the heat receiving projections need not be formed.

In the above embodiments, the drive device is applied to the main motor of the electric motorcycle. In another embodiment, the drive device may be applied to a motor other than the main motor. Alternatively, the drive device may be applied to a vehicle other than the electric motorcycle, or to an apparatus other than the on-vehicle applications.

The present disclosure is not limited to the embodiments described above and can be implemented in various forms without departing from the spirit of the present disclosure.

The present disclosure has been described with reference to the embodiments. However, the present disclosure is not limited to the above embodiments and the structures described therein. The present disclosure also includes various variations and variations within the equivalent range. Also, various combinations and forms, as well as other combinations and forms that include only one element, more, or less, are within the scope and ideology of the present disclosure.

What is claimed is:

1. A drive device comprising:
a motor unit that includes:
a stator around which a plurality of motor windings are wound;
a rotor that is configured to be rotated in response to energization of the plurality of motor windings; and
a shaft that is configured to be rotated integrally with the rotor;
a circuit unit that includes a circuit board on which a plurality of electronic components configured to control the energization of the plurality of motor windings are mounted, wherein the circuit board extends outward beyond a motor region that overlaps with the motor unit when the motor unit is projected onto the circuit board in an axial direction of the motor unit; and
a housing that includes:
a housing main body that has a motor housing portion, which receives the motor unit, and a circuit housing portion, which receives the circuit unit and is formed integrally in one-piece with the motor housing portion; and
a cover that covers an opening of the housing main body which opens at the circuit housing portion, wherein at least one of the housing main body and the cover is configured to receive heat generated from the circuit unit, wherein:
the housing has a plurality of heat dissipation portions; and
the plurality of heat dissipation portions include a plurality of peripheral-wall heat dissipation portions, each of which projects from a peripheral wall portion of the housing that surrounds an outer periphery of the circuit board.

2. The drive device according to claim 1, wherein the at least one of the housing main body and the cover has a board facing surface which faces the circuit board, and the board facing surface has a heat receiving projection formed at a location where at least one of the plurality of electronic components, which requires heat dissipation, is mounted.

3. The drive device according to claim 1, wherein the plurality of heat dissipation portions include a plurality of parallel-surface heat dissipation portions, each of which projects from an outer surface of the housing that is parallel with a mounting surface of the circuit board.

4. The drive device according to claim 1, wherein:
the housing main body has a tubular portion that receives the motor unit on a radially inner side of the tubular portion; and
the plurality of heat dissipation portions include a plurality of motor heat dissipation portions, each of which radially outwardly projects from the tubular portion.

5. The drive device according to claim 1, wherein:
the plurality of electronic components include a plurality of switching devices that are configured to switch the energization among the plurality of motor windings; and
at least one of the plurality of switching devices is disposed in an extension region of the circuit board that is located outside the motor region.

6. The drive device according to claim 1, wherein:
the drive device is configured to be mounted on a vehicle in a state where the drive device is exposed to an outside of the vehicle; and
the plurality of heat dissipation portions include a plurality of linear heat dissipation portions that are formed linearly in the circuit housing portion and are arranged to extend in a flow direction of cooling air, which is generated when the vehicle is running.
